(19) United States
(12) Patent Application Publication
(10) Pub. No.: US 2017/0330111 A1
(43) Pub. Date: Nov. 16, 2017

(54) SYSTEMS AND METHODS FOR MANAGING TRAVEL OPTIONS

(71) Applicant: RideSage Inc., Emeryville, CA (US)

(72) Inventors: Henry Vogel, Saratoga, CA (US); Paul Lo, San Jose, CA (US); Andrew Tsukahira, Los Angeles, CA (US)

(73) Assignee: RideSage Inc., Emeryville, CA (US)

(21) Appl. No.: 15/591,568

(22) Filed: May 10, 2017

Related U.S. Application Data
(60) Provisional application No. 62/335,234, filed on May 12, 2016.

(51) Int. Cl. G06Q 10/02; G01C 21/36; G06N 5/04; G06Q 50/30; G06Q 30/02; G06Q 50/00

(52) U.S. Cl. CPC G06Q 10/02; G06N 5/04; G06Q 50/30; G01C 21/3694; G06Q 50/01; G06Q 30/0282

(57) ABSTRACT

Some embodiments of the invention are directed to techniques for enabling a traveler to book a ride through a ridesharing service in advance. Some embodiments are directed to making it easy for a traveler to book a ride in advance, by allowing the traveler to specify a starting location, a destination and a time at which they would like to arrive at the destination, so that different transportation options and/or a pick-up time may be identified. Some embodiments are directed to techniques for reminding the traveler of ride details as the departure time approaches, and for updates to be issued to the traveler if travel conditions (e.g., traffic, weather, emergencies, etc.) threaten to increase the amount of time needed to travel from the starting point to the destination location.

### RELATED APPLICATION

This application claims priority under 35 U.S.C. §119(e) to U.S. Provisional Patent Application Ser. No. 62/335,234, entitled “Systems And Methods For Managing Travel Options,” filed on May 12, 2016, bearing Attorney Docket No. B1453.70000US00, the entirety of which is incorporated by reference herein.

### BACKGROUND

Ridesharing services provide travelers with on-demand access to one-time hired rides. In general, ridesharing services make use of location services to match a traveler's starting location and destination with the locations of prospective drivers. Ridesharing services may also utilize social networking functionality to establish trust and accountability between travelers and drivers through ratings and reviews. For travelers, ridesharing services offer convenience, as they provide on-demand access to transportation between a starting point and destination which may be defined on short notice, and not just between a predefined set of locations, as public transit systems provide. For drivers, ridesharing services offer the opportunity to convert the excess carrying capacity afforded by their vehicles into extra income. Ridesharing services also tout the ability to service remote geographic areas which may not be appropriately served by public transit systems, and to optimize automobile usage and thereby reduce the impact automobiles have on the environment.

### SUMMARY

The inventors have appreciated several deficiencies with conventional ridesharing services. One deficiency is that travelers are not able to reserve rides in advance, due to legal constraints associated with drivers being independent contractors for, rather than employees of, the ridesharing services. Another deficiency recognized by the inventors is that travelers may sometimes have difficulty securing a ride at or near peak travel times (e.g., around rush hour), and/or from locations at which network connectivity (e.g., cellular service) is unreliable. Additionally, the inventors have appreciated that travelers who use the same ridesharing services over and over may not be aware of other, potentially less expensive and/or more convenient, transportation options.

The inventors have also appreciated that knowing a traveler's plans in advance may allow information on those plans to be analyzed, so as to present multiple options from which the traveler may choose to suit their needs for a particular trip. For example, information on a traveler's plans may be analyzed to identify the transportation options which are the least expensive, the most dependable, offer the shortest travel time to the traveler's destination, accommodate a particular number of passengers, etc. In addition, knowing a traveler's plans in advance allows for updating the traveler if/when conditions along their travel route change (e.g., if a weather event, traffic jam, etc. threatens to prolong travel time), so that the traveler may, for example, move up their departure time, choose another ridesharing service, update the number of passengers traveling with him/her, etc.

Some embodiments of the invention provide functionality which enables a traveler to book a ride through a ridesharing service in advance (e.g., at least a day prior to the ride occurring). Some embodiments of the invention may also, or alternatively, provide functionality which makes it easy for a traveler to book a ride in advance, by allowing the traveler to specify a starting location, a destination and a time at which they would like to arrive at the destination. This information may be analyzed to identify the different transportation options available to the traveler to get him/her to the specified destination by the appointed time (e.g., including ridesharing services and/or other options). These options may be presented to the traveler, along with information which assists the traveler in evaluating the options along any of numerous different dimensions, such as the departure time, price, travel time, number of passengers that can ride along, etc., associated with each option. After the traveler selects a particular transportation option, some embodiments of the invention may provide for reminders to be sent to the traveler as the departure time approaches, and for updates to be issued to the traveler if travel conditions (e.g., traffic, weather, emergencies, etc.) threaten to increase the amount of time needed to travel from the starting point to the destination location using the previously selected option. If so, the traveler may be prompted to change his/her departure time, select another transportation option, indicate a willingness to accept a later arrival time, etc. As such, some embodiments of the invention may enhance the convenience associated with certain transportation options, such as ridesharing services.

Some embodiments of the invention are directed to a computing system for enabling a traveler to reserve a ride. The computing system comprises: at least one computer-readable medium, having instructions encoded thereon; and at least one computer processor, programmed via the instructions to: receive first input from the traveler defining a pick-up location at which the traveler is to be picked up to commence the ride; receive second input from the traveler defining a destination location at which the traveler is to be dropped off to conclude the ride; receive third input from the traveler, the third input enabling a pick-up time to be determined for the ride; and based at least in part upon the first, second and third inputs received from the traveler, automatically identify a first transportation provider, affiliated with a first ridesharing service, to provide the ride to the traveler; wherein the first ridesharing service does not allow travelers to reserve rides more than a predetermined amount of time before a ride commences, and wherein the first, second and third input are received more than the predetermined amount of time prior to the ride commencing.

Some embodiments of the invention are directed to a computing system for enabling a traveler to reserve a ride. The computing system comprises: at least one computer-readable medium, having instructions encoded thereon; and at least one computer processor, programmed via the instructions to: receive first input from the traveler defining a pick-up location at which the traveler is to be picked up to commence the ride; receive second input from the traveler defining a destination location at which the traveler is to be dropped off to conclude the ride; based at least in part on the first and second inputs, automatically identify a plurality of ride options for the traveler, each of the plurality of ride options having an associated estimated cost and number of seats; cause information on each of the plurality of automatically identified ride options to be presented to the traveler, the information for each ride option comprising the estimated cost and number of seats; and receive third input from the traveler selecting a particular ride option, from the plurality of automatically identified ride options, for the ride;

wherein at least one of the plurality of ride options is to be provided by a ridesharing service which does not allow travelers to reserve rides more than a predetermined amount of time before a ride commences, and wherein the first and second input are received more than the predetermined amount of time prior to the ride commencing.

Some embodiments of the invention are directed to a computing system for enabling a traveler to reserve a ride. The computing system comprises: at least one computer-readable medium, having instructions encoded thereon; and at least one computer processor, programmed via the instructions to: receive input from a first traveler to reserve a ride with a ridesharing service, the ride to commence at a first time when the traveler is to be picked up, and to end at a second time when the traveler is to be dropped off; after the input is received and before the first time, determining that the ridesharing service is unable to both pick up the traveler at the first time and drop off the traveler at the second time; in response to the determining, prompting the traveler to change at least one of the ridesharing service, the first time when the traveler is to be picked up, and the second time when the traveler is to be dropped off.

The foregoing is a non-limiting summary of only certain aspects of the invention, some embodiments of which are described in the sections that follow.

### BRIEF DESCRIPTION OF DRAWINGS

The accompanying drawings are not intended to be drawn to scale. In the drawings, each identical or nearly identical component illustrated in the various figures is represented by a like numeral. For purposes of clarity, not every component may be labeled in every drawing. In the drawings:

FIG. 1 is a flowchart depicting a representative process for enabling a traveler to pre-book transportation to a specified destination, in accordance with some embodiments of the invention;

FIGS. 2-22 depict representative screen interfaces for presenting information to, and receiving information from, a traveler in relation to the process shown in FIG. 1, in accordance with some embodiments of the invention;

FIG. 23 is a flowchart depicting a representative process for enabling a traveler to evaluate various transportation options, in accordance with some embodiments of the invention;

FIGS. 24-38 depict representative screen interfaces for presenting information to, and receiving information from, a traveler in relation to the process shown in FIG. 23, in accordance with some embodiments of the invention;

FIG. 39 is a flowchart depicting a representative process for prompting a traveler to alter his/her travel plans in response to changing travel conditions, in accordance with some embodiments of the invention;

FIGS. 40-45 depict representative screen interfaces for notifying a traveler of information relating to a planned trip, in relation to the process shown in FIG. 39, in accordance with some embodiments of the invention;

FIG. 46 depicts a representative screen interface for prompting a traveler to provide feedback on a trip, in accordance with some embodiments of the invention;

FIG. 47 depicts a representative screen interface for receiving feedback on a trip from a traveler, in accordance with some embodiments of the invention;

FIG. 48 is a block diagram depicting a representative system architecture for providing functionality relating to enabling travelers to manage transportation options, in accordance with some embodiments of the invention;

FIG. 49 is a block diagram depicting a representative computer system which may be used to implement certain aspects of the invention.

### DETAILED DESCRIPTION

In accordance with some embodiments of the invention, functionality may be provided to enable a traveler to reserve a ride with a ridesharing service in advance (e.g., at least a day prior to the ride occurring). For example, some embodiments may enable a traveler to specify a starting location, a destination and a time at or by which they would like to arrive at the destination. This information may be analyzed to identify the transportation options available to the traveler to transport him/her to the specified destination by the appointed time. These options may be presented to the traveler, along with information to assist him/her in selecting a particular option. Any of numerous types of information may be presented, such as the departure time, price, travel time, number of passengers that can ride along, etc. associated with each option. The traveler may review this information to evaluate the options presented. When the traveler selects a particular transportation option, that option may be reserved for an associated departure time, and reminders may thereafter be sent to the traveler as the departure time approaches. Additionally, updates may be sent to the traveler before the scheduled departure time if changing conditions (e.g., traffic, weather, an emergency, etc.) threaten to delay his/her travel plans. If so, the traveler may be prompted to change any of various details associated with the trip, such as to select an earlier departure time, select another transportation option instead which may be more likely to transport the traveler to the destination by the originally specified time, indicate a willingness to accept a later arrival time, and/or to provide other input to assist in arranging the trip.

In some embodiments of the invention, this and other functionality may be provided to a traveler via one or more “apps” configured for execution on a mobile device (e.g., a smartphone, tablet, gaming console, navigation device, and/or any other mobile device, whether now known or later developed), such as a mobile device which is operated by the traveler. Of course, the invention is not limited to being implemented, wholly or in part, via an app executing on a mobile device, as numerous modes of implementation are possible. For example, any or all of the functionality disclosed herein may be provided, wholly or in part, by any one or more program modules, configured for execution on any suitable computing device(s), whether now known or later developed, including but not limited to personal computers, laptop computers, and servers. In embodiments which employ an app executing on a mobile device to deliver functionality to a traveler, the app may, for example, be in networked communication with one or more program modules executing on other computing devices, such as one or more server computers, such as to request any of numerous types of information.

In some embodiments of the invention, functionality may be provided to travelers which may be generally categorized as (1) enabling a traveler to pre-book transportation to a specified destination; (2) enabling a traveler to evaluate various transportation options to get him/her to the destination according to specified trip criteria; and/or (3) prompting the traveler to make changes to his/her plans in response to changing travel conditions. These three areas of functionality are described in the sections that follow.

### A. Enabling a Traveler to Pre-Book Transportation to a Specified Destination

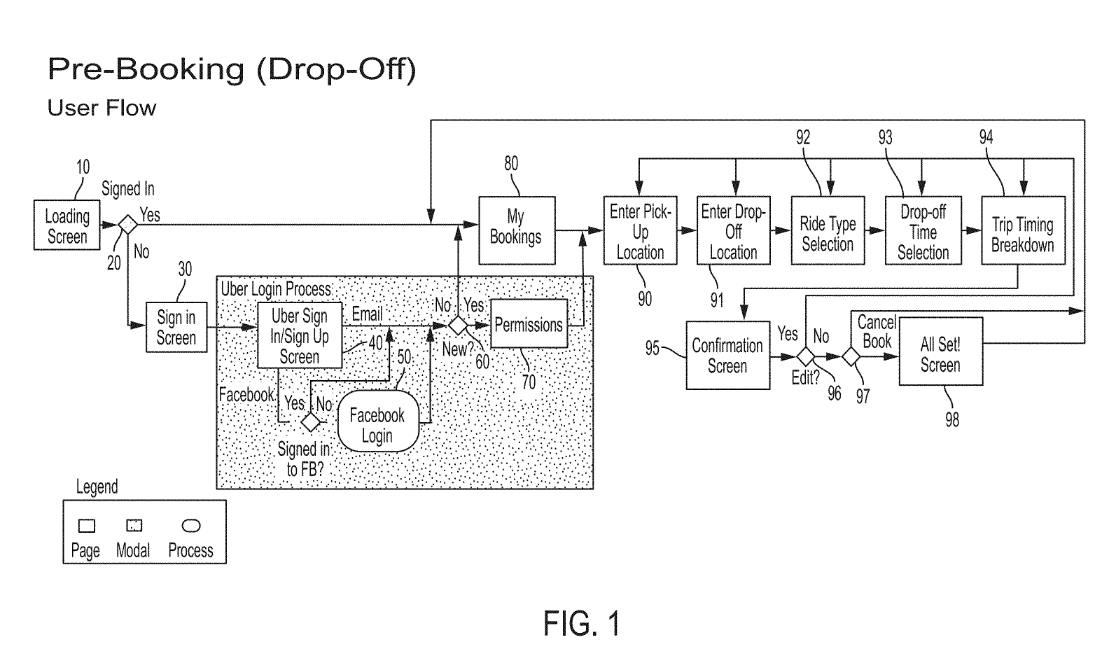

FIG. 1 depicts a representative process for enabling a traveler to pre-book transportation to a destination. The process shown in FIG. 1 may, for example, be performed by or using one or more program modules which receive input provided by a traveler and process this and other information (e.g., requested from one or more other program modules executing on a server computer) to enable a traveler to arrange transportation to occur in the future (e.g., at least one day in advance of the anticipated start time of the trip).

In the representative process shown in FIG. 1 and described below, the traveler pre-books a ride from a ridesharing service. However, it should be appreciated that numerous variations on the process shown in FIG. 1 are possible, including some in which embodiments of the invention allow a traveler to pre-book any of numerous other transportation options.

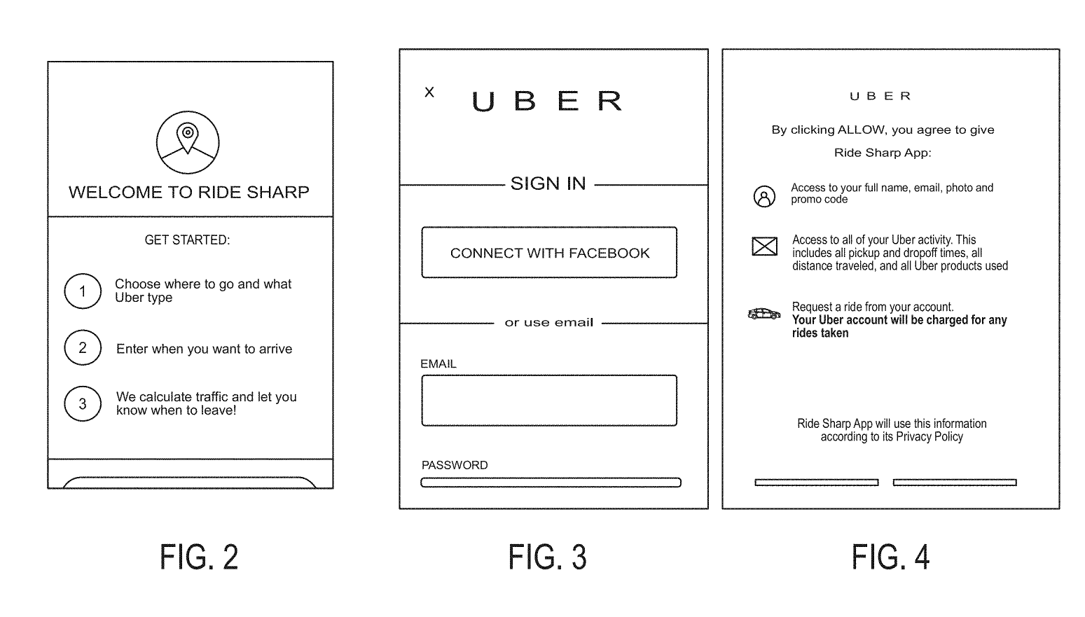

At the start of the process shown in FIG. 1, a loading screen is displayed to the traveler in act 10 to make the traveler aware of various functionality provided by the program module(s). An example of such a loading screen is shown in FIG. 2.The process then proceeds to act 20, wherein a determination is made whether the traveler is signed into the service providing the pre-booking functionality described. This determination may be made in any of numerous ways, such as by prompting the traveler to indicate whether or not he/she is signed into the service.

If the traveler is not signed in, then a sign-in screen is presented to the traveler in the act 30. The process then continues with a procedure by which the traveler logs into a particular ridesharing service (in the example shown, the UBER ridesharing service, although it should be appreciated that embodiments of the invention may be used in conjunction with any suitable ridesharing service(s)) in act 40. An example sign-in/sign-up screen is shown in FIG. 3. If the traveler opts to “connect with Facebook,” then he/she may be prompted to sign into the Facebook service in act 50, and then may be automatically logged in to the ridesharing service with his/her Facebook credentials. If the traveler opts to instead sign-in using their email address and password, then the process proceeds to act 60, wherein a determination is made whether the traveler is a new user to the ridesharing service. If not, the process proceeds to act 80, wherein the travelers is shown any previously-established bookings in act 80. If the traveler is new to the ridesharing service, then the process proceeds to act 70, wherein permissions for the traveler are defined. At the completion of either of act 70 or act 80, the process proceeds to act 90, wherein the traveler specifies a pickup location.

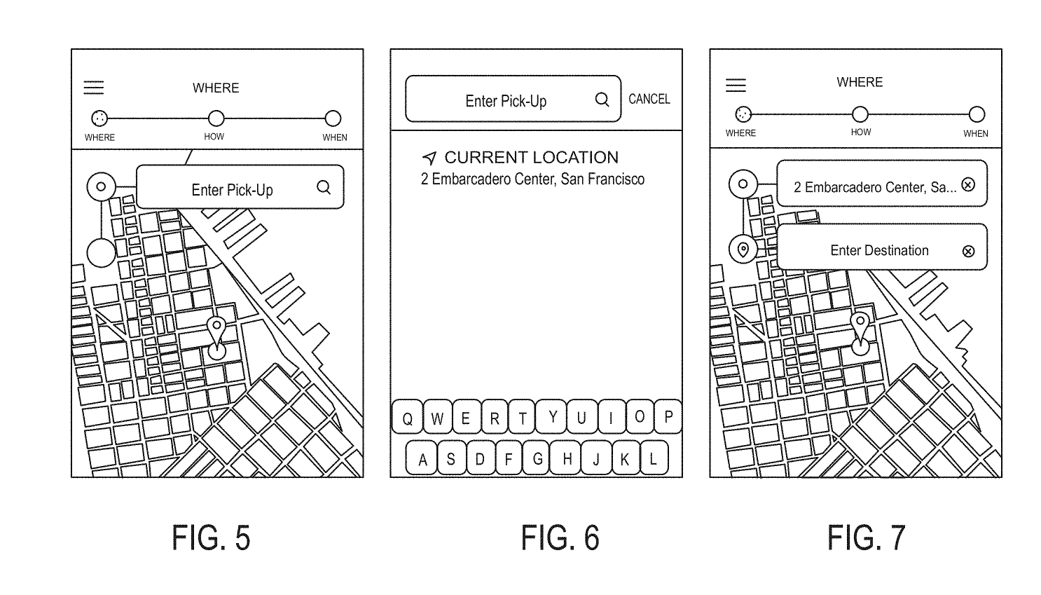

A traveler may specify a pickup location in any of numerous ways. In the example shown in FIGS. 5-7, a traveler is shown a facility to which he/she may provide input (e.g., typewritten input, voice input, etc.) describing a particular pick-up location, or indicate that the pick-up location is to be his/her current location. In the example shown, the user has indicated that his/her current location (i.e., Two Embarcadero Center in San Francisco, Calif.) is to be the pick-up location, and this location is represented on a map display.

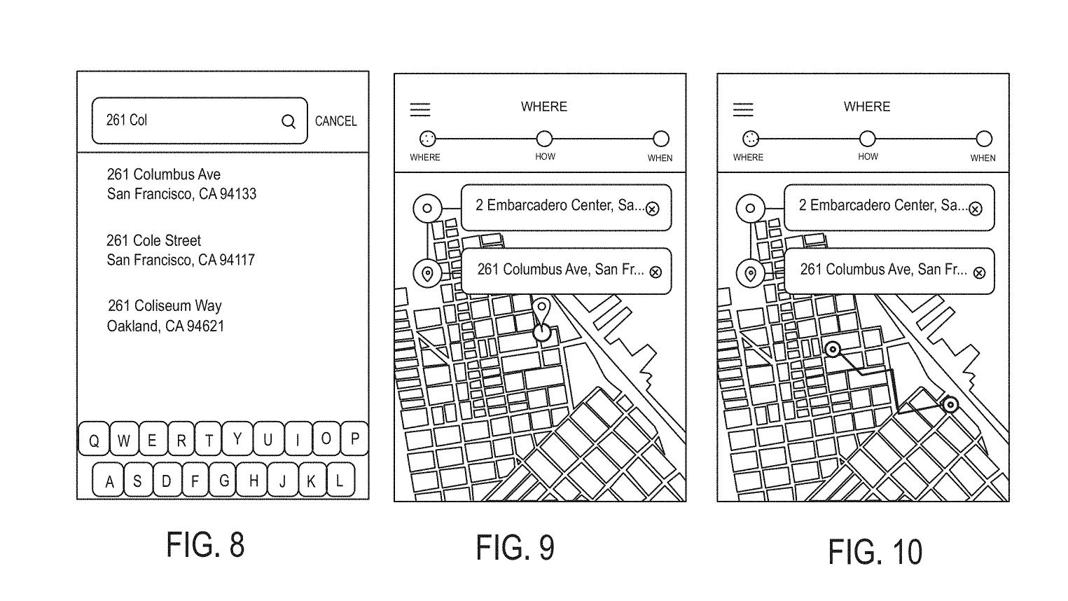

The process then proceeds to act 91, wherein the traveler is prompted to specify a destination location. This, too, may be performed in any of numerous ways. In FIG. 7, a representative facility is depicted to which the traveler may provide input to specify a destination location. In the example shown in FIG. 7, if the traveler begins to provide typewritten input, then the screen shown in FIG. 8 is presented, which shows the results of a prediction algorithm based upon the input supplied by the traveler so as to reduce the number of keystrokes the traveler must perform to identify the destination. In the example shown in FIG. 8, the user selects the prediction algorithm result “261 Columbus Ave., San Francisco, Calif. 91433,” and this location is represented on the map shown in FIG. 9. A representation of the travel route between the pick-up location and the drop-off location is shown in FIG. 10.

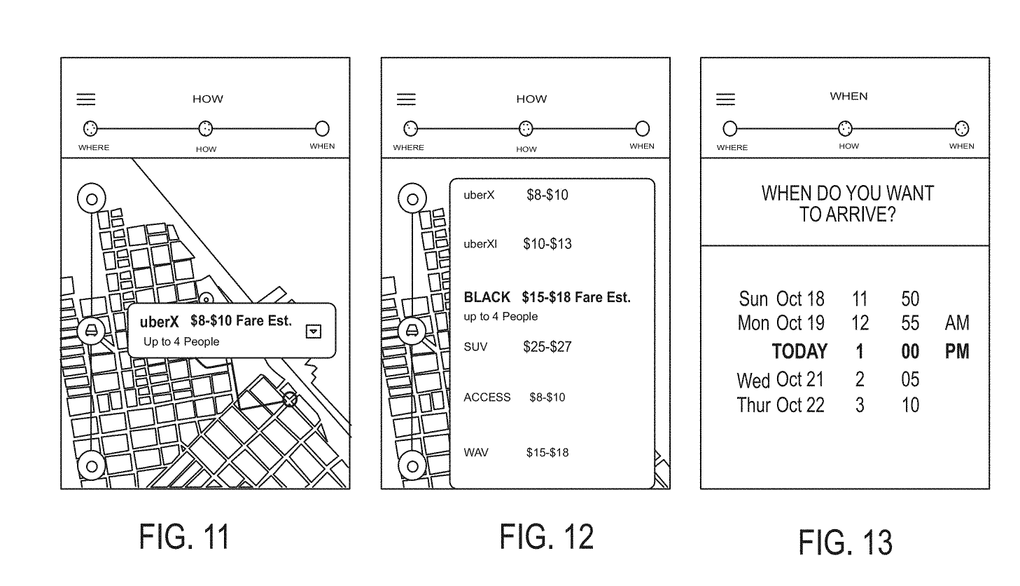

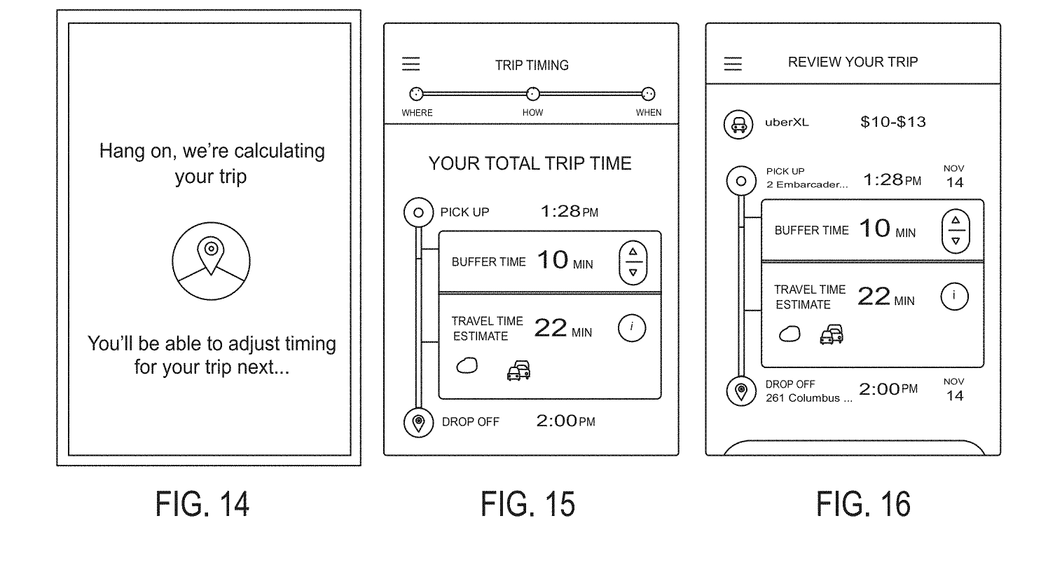

The process then proceeds to act 92, wherein the user selects a ride type from among various options. In the example shown in FIG. 12, six different ride options are presented to the traveler, each having a different anticipated fair and passenger capacity. For example, the ride option labeled “Black” has an associated estimated fair of $15-$18, and can accommodate up to four people. In the example shown, the traveler selects the ride option “UberX”, which has an associated estimated fair of $8-$10 and can accommodate up to four travelers, as shown in FIG. 11.

The process then proceeds to act 93, wherein the traveler specifies a drop-off time (i.e., a time at which they wish to arrive at the destination). This may be performed in any of numerous ways. In the example shown in FIG. 13, the traveler specifies a day and time at which he/she wishes to arrive at the drop-off location by selecting from options presented on a scroll wheel, as is known in the art. In the example shown, the traveler has indicated that he/she has specified a drop-off time of “today” at “1:00 p.m.” Of course, a traveler may specify a day and time in any suitable way.

Based on the input provided by the traveler in the acts 90-93, the system then automatically determines the time at which the traveler should be picked up at the starting location to be able to arrive at the drop-off location at the specified time using the specified ride option. In the example shown in FIG. 15, the travelers indication of a drop-off time of 2:00 p.m. and a particular ride type results in a pick-up time of 1:28 p.m. being calculated, with the 32 minutes between the pick-up time and drop-off time being based upon an anticipated travel time of 22 minutes, and a buffer time of 10 minutes, for the selected mode of transportation. In some embodiments (such as the examples shown in FIGS. 15-16), the traveler may be given the ability to increase or decrease the buffer time, so as to manipulate the pick-up time at which a driver from the specified ridesharing service may arrive at the pick-up location. In some embodiments, the traveler may also, or alternatively, be given an indication of circumstances which could affect the anticipated travel time, such as traffic, weather, an emergency, and/or other circumstances.

In some embodiments of the invention, a traveler may be given the ability to select a different mode of transportation if he/she is dissatisfied with the anticipated travel time. For example, as shown in FIG. 16, while an initially selected ride type may yield a travel time of 22 minutes, there may be an alternative ride type which has a shorter anticipated travel time, and which may be reserved (e.g., at a different price) than the originally selected ridesharing service. By selecting an alternative ridesharing service, a traveler may cause changes to the travel time, pick-up time and/or price associated with a trip. Thus, it can be seen that some embodiments of the invention may enable a traveler to make decisions relating to modes of transportation based upon information provided about the various modes.

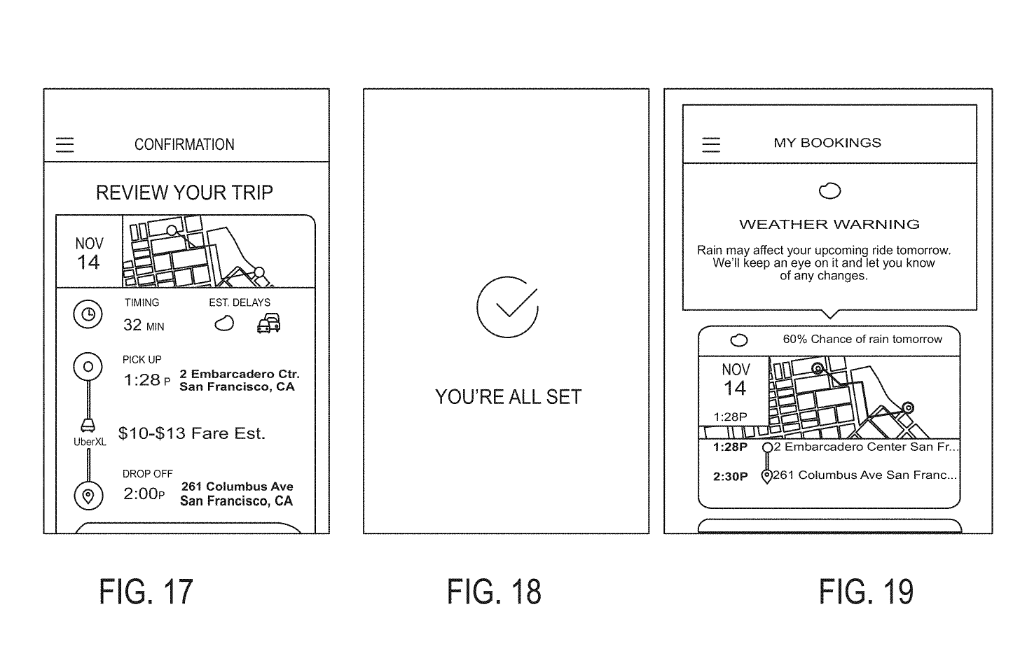

The process then proceeds to acts 95, wherein the traveler is prompted to confirm his/her travel plans. FIG. 17 shows a representative screen interface through which a traveler may be prompted to confirm his/her plans. In act 96, a determination is made whether the traveler wishes to edit his/her travel plans. If so, then the process shown in FIG. 1 returns to any of acts 90-94, depending on which aspect of the originally-specified travel plans the traveler wishes to edit.

If the user does not wish to edit his/her travel plans, then the process proceeds to act 97, wherein a determination is made whether the user wishes to book or cancel his/her travel plans.

If the user wishes to cancel, the process returns to act 80, and then continues as described above. If the traveler wishes to book the travel plans by reserving a ride with the selected ridesharing service, the process proceeds to act 98, wherein the user is notified of the booking being set. A representative notification is shown in FIG. 18.

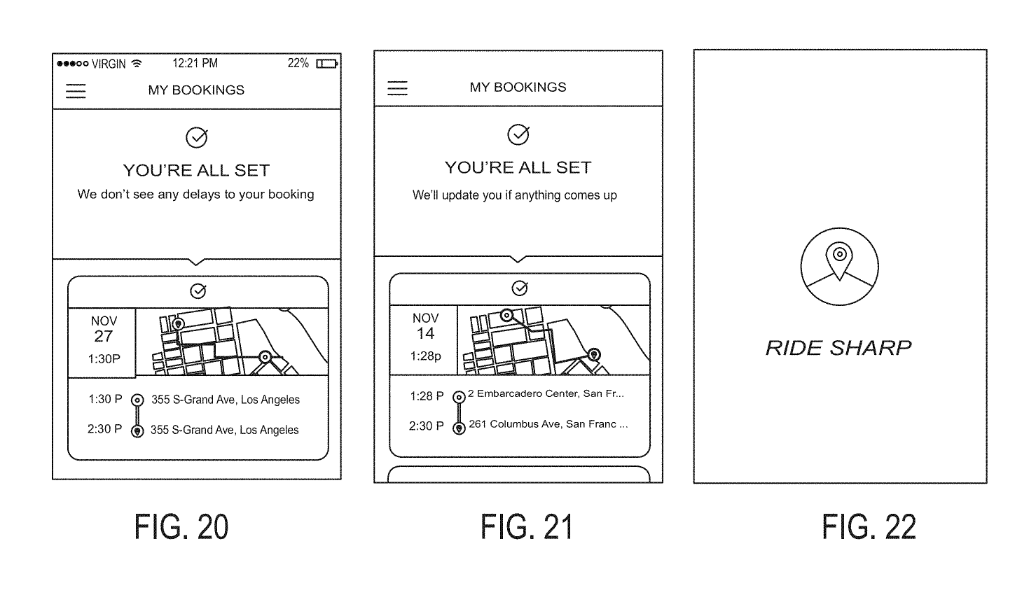

In some embodiments of the invention, the traveler may be notified if it appears travel conditions may affect a previously booked trip. For example, FIG. 19 depicts a notification issued to a traveler to indicate that inclement weather may increase the travel time associated with a reserved trip. FIGS. 20 and 21 show representative notifications that no travel delays are anticipated, and that the user will be notified if any potential delays are identified. The process of FIG. 1 then completes.

Given that conventional ridesharing services do not allow rides to be reserved in advance, some embodiments of the invention provide functionality for communicating with a ridesharing service as the time for a reserved trip draws near to reserve a ride for a traveler. Such functionality may be provided in any of numerous ways, such as via one or more program modules which communicate with an application provided by a ridesharing service. A representative process whereby program modules may communicate with a ridesharing application to automatically secure a ride which a traveler has pre-booked as the scheduled departure time for the ride draws near is described below.

If a traveler's trip is to occur within a predefined time period (e.g., less than 30 minutes in the future), then communication with a ridesharing service may be attempted immediately. For example, a ridesharing application may be queried to determine whether any drivers are then in the traveler's area. If so, a driver and ride may be reserved for the traveler, and the traveler may be notified that booking is successful. If no drivers are then in the traveler's area, the traveler may be notified, and asked whether he/she wishes to continue to try booking the ride or cancel. If the traveler indicates that he/she wishes to continue, then the ridesharing service may be queried again, and this process may be substantially continuously repeated until either a driver is located in the traveler's area or the traveler cancels the trip.

In some embodiments of the invention, no communication with a ridesharing service is attempted until a predefined time (e.g., 30 minutes, 45 minutes, or any other suitable time period) prior to the scheduled departure time for a trip. The description that follows assumes that the predefined time period is 30 minutes.

If a traveler's scheduled departure time is in 30 minutes or less, then a ridesharing service may be queried substantially continuously (e.g., once every 10 seconds, or at any other suitable interval) until a driver is located in the traveler's area. Once at least one driver is found in the traveler's area, a determination is made whether any identified driver is able to pick up the traveler by the scheduled departure time. If at least one driver can pick up the traveler at that time, then a ride with that driver at that time is reserved with the ridesharing service. The traveler is notified of the booking, and may be able to track the driver's progress toward his/her location on a map and/or through text notifications, and/or may be notified when the driver arrives at his/her location.

If no drivers are identified in the traveler's area who can pick up the traveler at the scheduled departure time, then communication with the ridesharing service is re-attempted substantially continuously until the scheduled departure time. The traveler may be notified as the scheduled departure time draws near that no driver has yet been located, and that attempts to find a driver will continue unless the traveler cancels the trip.

If no driver is located by the scheduled departure time, the traveler is notified that no driver has been found. The traveler may be prompted to indicate whether attempts to find a driver should continue, or if the request is to be cancelled.

### B. Enabling A Traveler To Evaluate Various Transportation Options

The inventors have appreciated that, in some circumstances, a traveler may not wish to have a pick-up time be automatically determined based upon a specified drop-off time. Accordingly, some embodiments of the invention enable a traveler to specify a pick-up time, and select from among various transportation options to transport the traveler to a specified drop-off location. Various transportation options may be presented, so as to enable the traveler to manage various considerations including the cost of the trip, estimated travel time, number of passengers to accompany the traveler, etc.

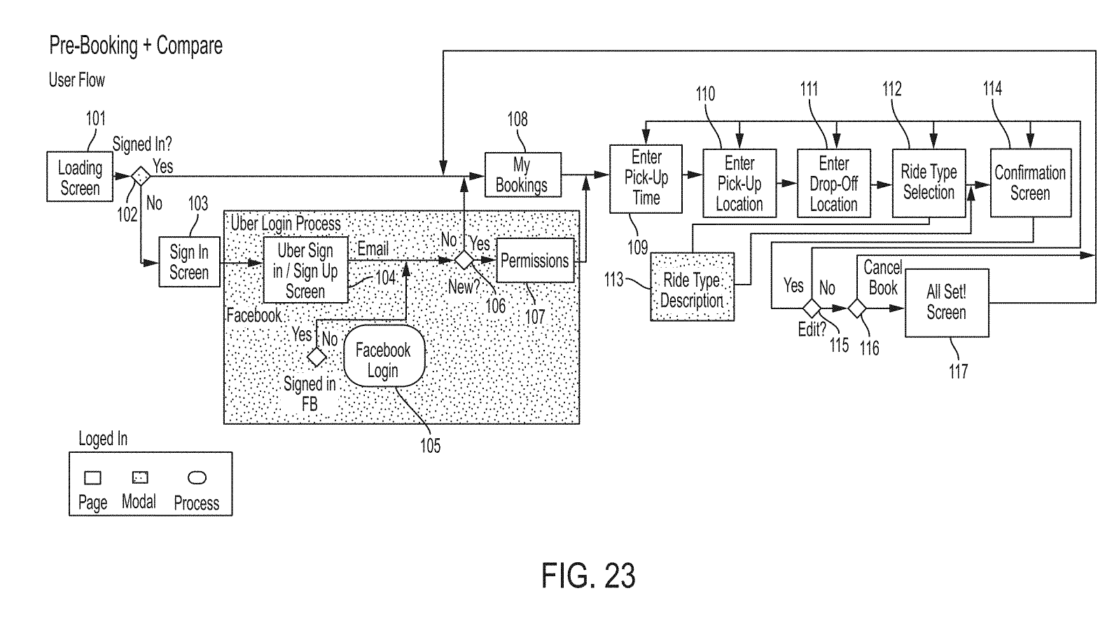

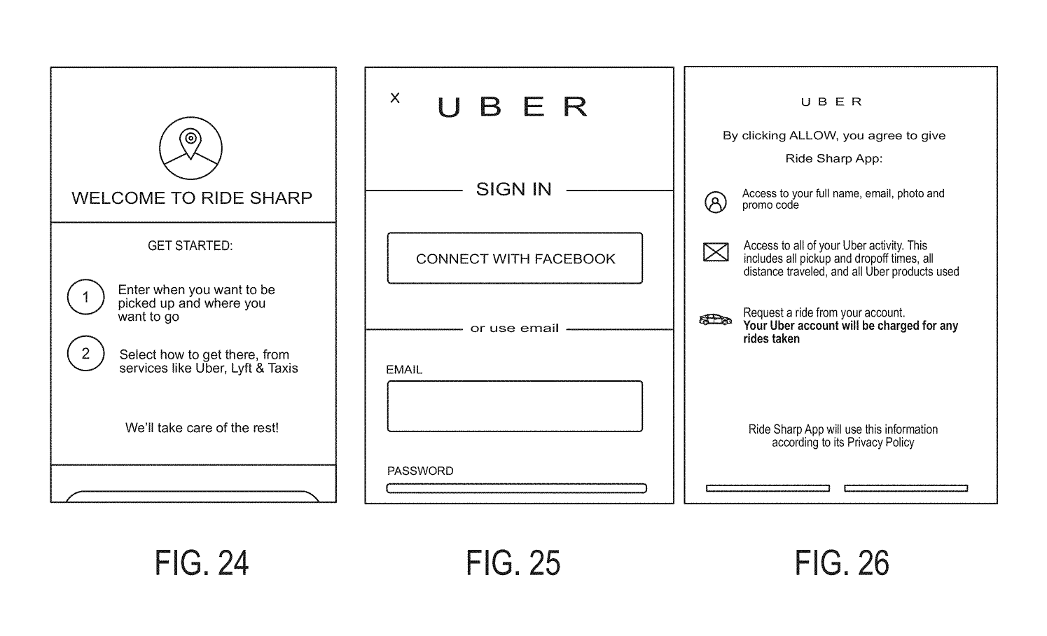

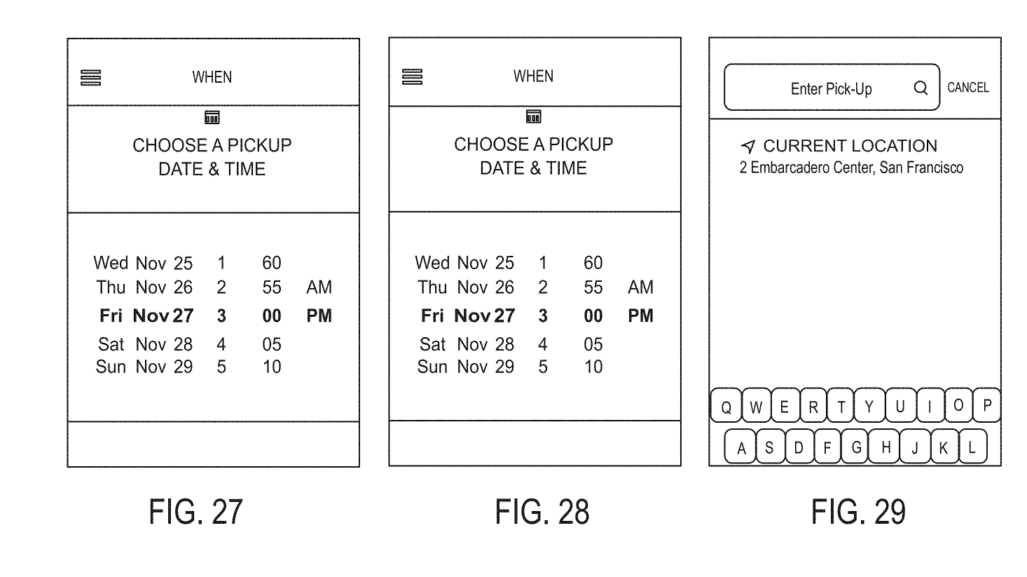

A representative process for enabling a traveler to evaluate various transportation options is shown in FIG. 23. The process of FIG. 23 begin in act 101, wherein the traveler is shown a loading screen in act 101. A determination is then made in act 102 whether the traveler is signed in to a ridesharing service. If so, the process proceeds to act 108, which is substantially similar to the act 80 described above with reference to FIG. 1. If it is determined in the act 102 that the user is not yet signed into a ridesharing service, then the process of FIG. 23 proceeds to act 103, and then to a ridesharing service log in process, which is substantially similar to the process described above in relation to acts 30-70 shown in FIG. 1. An example of a ridesharing service sign-in/sign-up screen is shown in FIG. 25.

Whether it is determined in the act 102 that the traveler is signed into a ridesharing service, or it is determined in the act 106 that the traveler is not new to the booking service, the process of FIG. 23 proceeds to act 108, wherein the traveler is shown any previously arranged bookings. At the completion of act 108, or if it is determined in the act 106 that the traveler is new to the booking service, so that permissions for the user are specified in the act 107, the process of FIG. 23 proceeds to act 109, wherein the user specifies a pick-up time. This may be performed in any of numerous ways. A representative screen interface through which a user may specify a pick-up time is shown in FIG. 28, which presents pick-up dates and times as options on a scroll wheel.

The process of FIG. 23 then proceeds to act 110, wherein the user specifies a pick-up location. In some embodiments, act 110 may be performed in a fashion which is substantially similar to that which is described above in relation to FIGS. 5-6 and act 90 of the process of FIG. 1. In this respect, FIG. 29 depicts a representative screen interface which a traveler may employ to supply input (e.g., typewritten input) to indicate a particular pick-up location. The pick-up location may, for example, be the traveler's current location, and so a location determination facility may be used to specify a pick-up location. Of course, a traveler may specify any suitable location as a pick-up location.

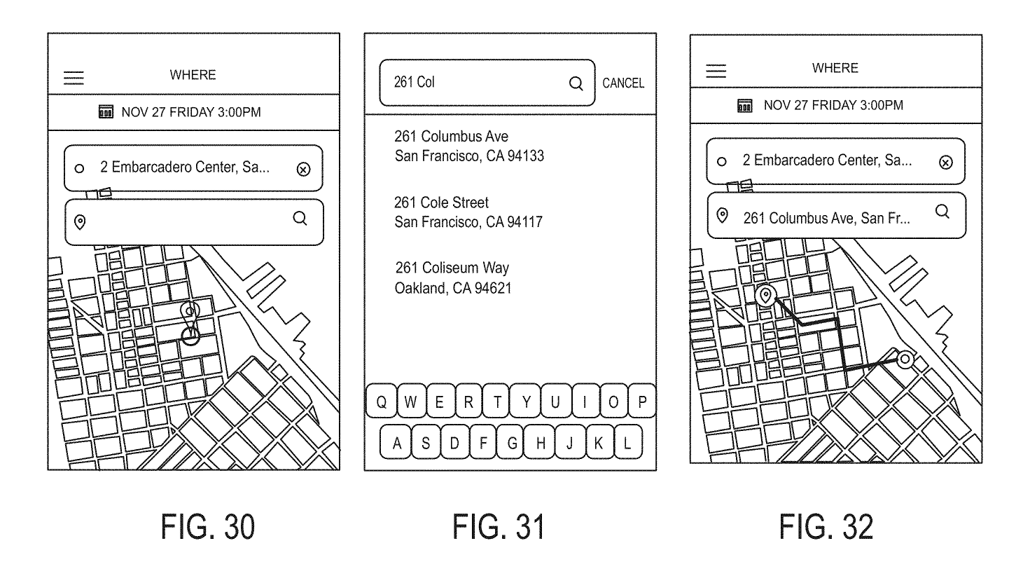

The process of FIG. 23 then proceeds to act 111, wherein the user specifies a drop-off location. In some embodiments, act 111 may be performed in a fashion which is substantially similar to that which is described above in relation to FIGS. 7-9 and act 91 in the process of FIG. 1. In this respect, FIG. 30 depicts an input facility which a traveler may use to provide typewritten input specifying a drop-off location, causing the screen interface of FIG. 31 to be shown, wherein a prediction algorithm seeks to minimize the number of keystrokes the traveler must enter to specify the drop-off location. FIG. 32 depicts on a map a travel route between the pick-up and drop-off locations specified by the user in the acts 110 and 111, respectively.

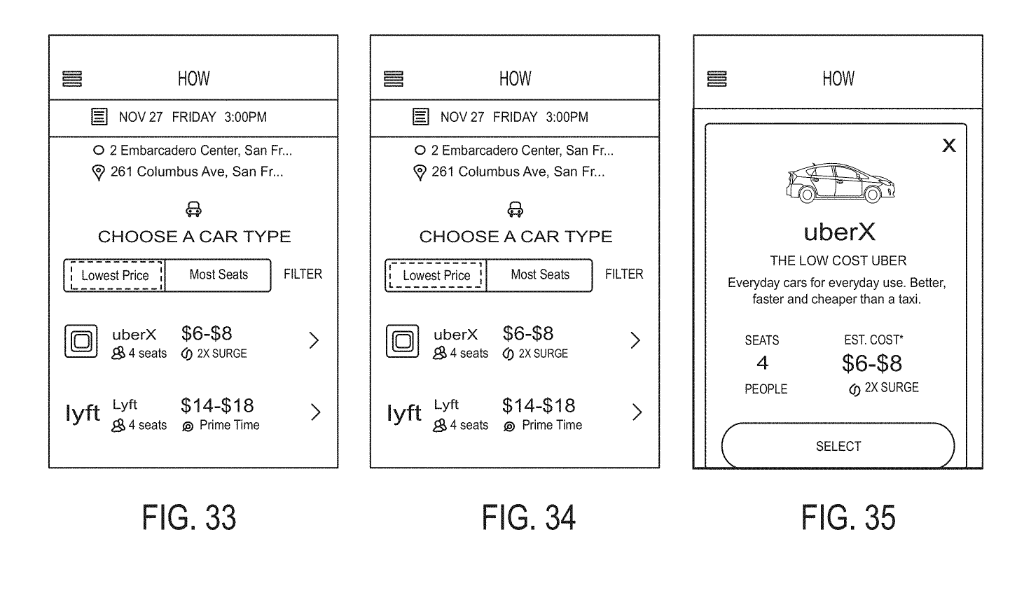

The process of FIG. 23 then proceeds to act 112, wherein the traveler selects a particular ride type. This may be performed in any numerous ways. FIG. 33 depicts a representative screen interface for presenting various ride type options. In the example shown, these options are sorted by estimated fare, although the traveler may instead cause options to be sorted according to other details, such as the number of passengers each ride type will accommodate (by providing touch input to the “most seats” option shown in FIG. 33). The screen interface shown in FIG. 33 also enables the traveler to filter the options shown, such as to remove options having an estimated fare above a certain price, ride types provided by particular ridesharing services, etc.

In optional act 113, a traveler may obtain more information on a ride type option and/or select the ride type by providing touch input to the arrow on the considered row, thereby causing the representative screen interface shown in FIG. 35 to be shown. The traveler may return to the list of options shown in FIG. 33 by providing touch input to the “X” in the corner of the screen interface shown in FIG. 35, or select the chosen ride type for use by providing touch input to the “select” button.

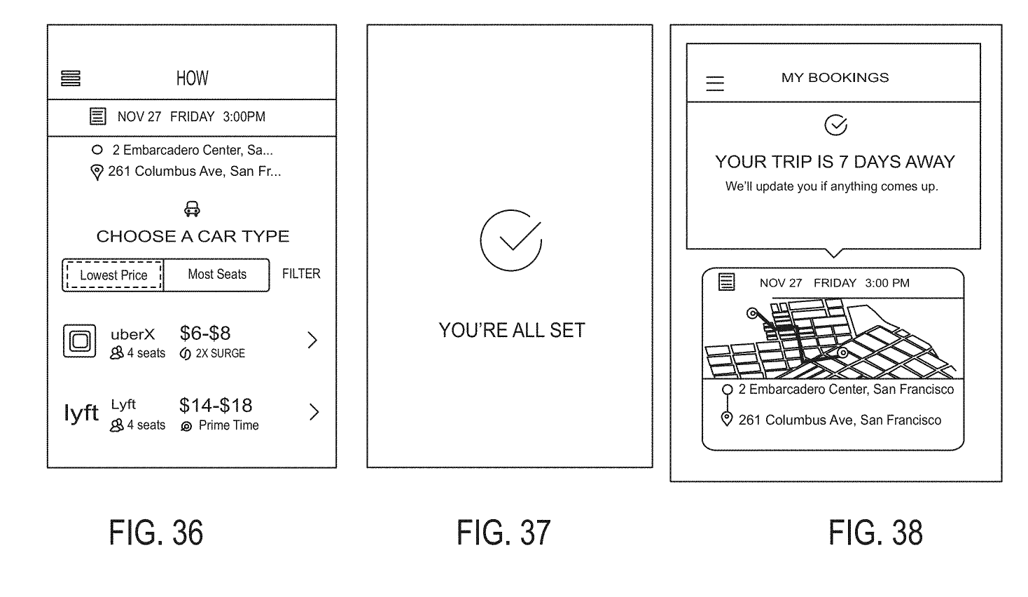

The process of FIG. 23 then proceeds to act 114, wherein a confirmation screen is presented to the traveler. An example confirmation screen is shown in FIG. 36. A determination is then made in act 115 whether the traveler wishes to edit his/her travel plan. If so, the process of FIG. 23 may return to any of acts 109-112 to enable the traveler to edit a specified aspect of the plan. If it is determined in the act 115 that no editing is desired, the process of FIG. 23 then proceeds to act 116, wherein a determination is made whether the traveler wishes to cancel the travel plans. If so, the process returns to the act 108, and then resumes as described above. If not, the traveler is notified that he/she is all set.

### C. Prompting A Traveler To Alter Travel Plans In Response To Changing Travel Conditions

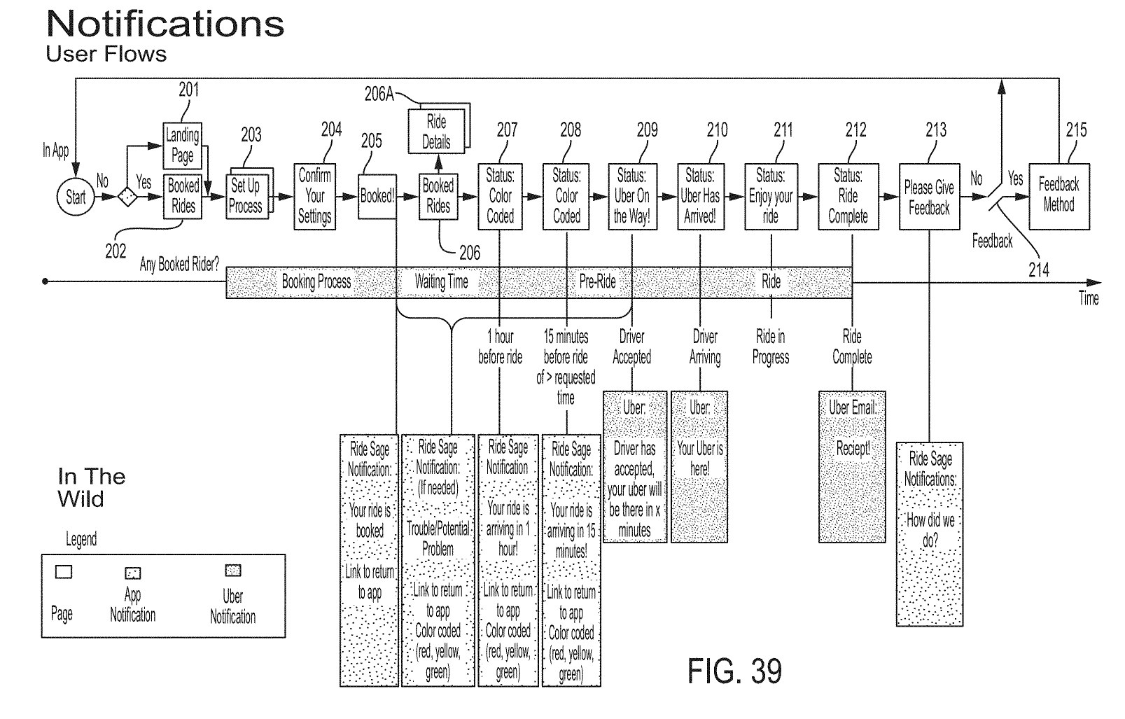

FIG. 39 depicts a representative process for notifying a traveler prior to a planned trip that changing travel conditions may warrant changes to the trip. At the start of the process of FIG. 39, a determination is made whether the traveler previously booked any rides. If not, the traveler is presented with a landing page in act 201. If so, the traveler is presented with one or more pages indicating details for the booked trips at the completion of either act 201 or 202.

The process then proceeds to a booking process which encompasses acts 203, 204 and 205. In some embodiments, acts 203-205 may be performed in a fashion which is similar to that which is described above in relation to acts 90-94 of the process shown in FIG. 1. At the completion of act 205, a traveler has booked a ride to occur in the future, and is waiting for the ride to occur.

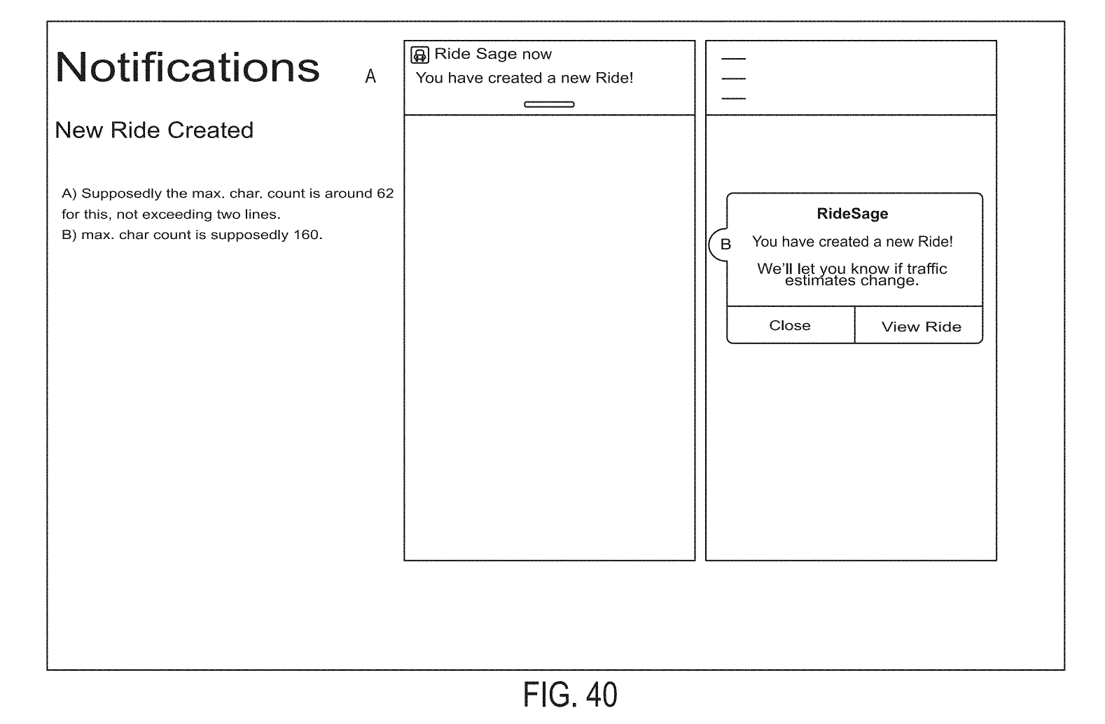

During this “waiting time” shown in FIG. 39, any of various notifications may be sent to the traveler. A first representative notification, shown in FIG. 40, may occur when the traveler books a new ride. That is, at the completion of act 205, the traveler may be shown a notification which indicates that they have created a new ride and that they will be notified if changes are needed. The process of FIG. 39 then proceeds to act 206, wherein the traveler is shown information on booked rides. Optionally, the details on one or more particular booked rides may be shown to the traveler in act 206A.

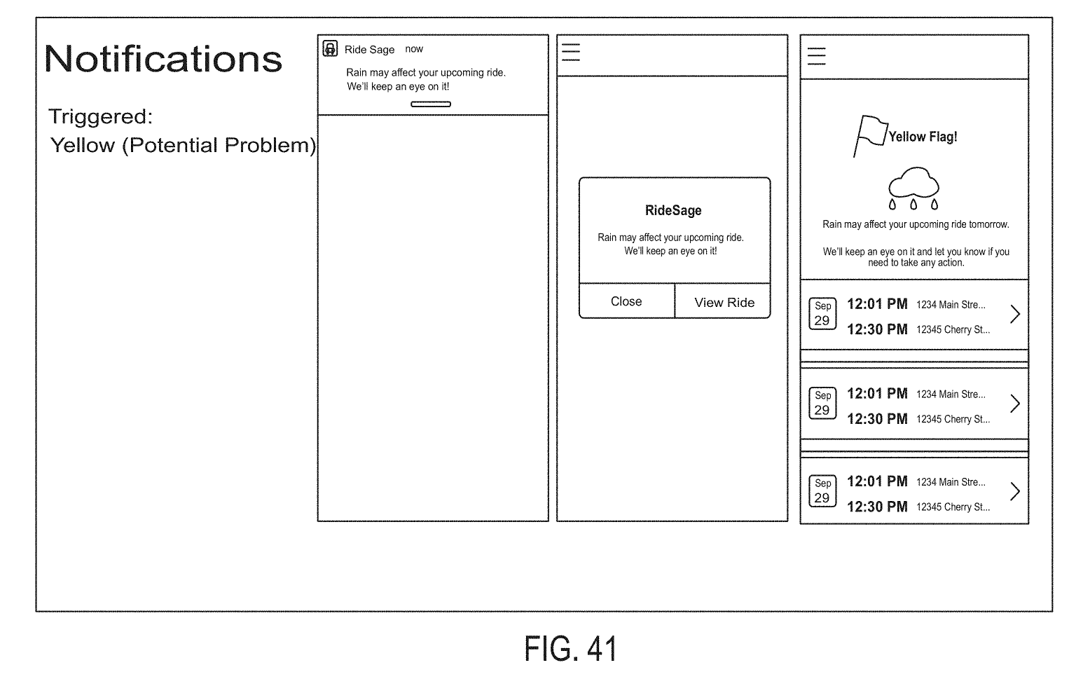

Another type of notification may be sent to a traveler at some point between the completion of act 205 and the ride occurring. FIG. 41 depicts a representative notification, sent to the traveler in act 207, that predicted weather conditions may affect the time needed to get the traveler from the starting point to the destination, such that the traveler may wish to alter his/her travel plans if he/she wishes to arrive at the destination at a particular time. In the example shown in FIG. 41, this weather prediction is designated a “yellow flag,” in that it notifies the traveler of a potential problem which may or may not actually come to pass. In the example shown, the traveler is informed that rain is predicted for the area encompassing the travel route during the trip. The traveler then has the ability to change the pick-up time and/or ridesharing option to make it more likely that he/she reaches the destination by the appointed time.

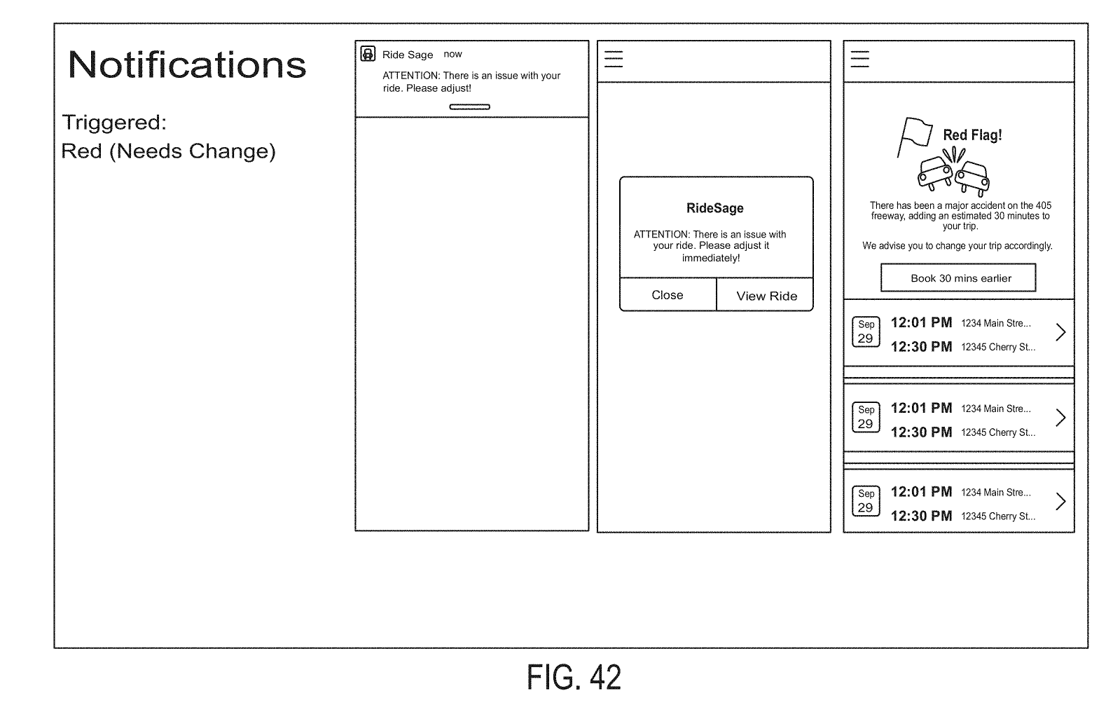

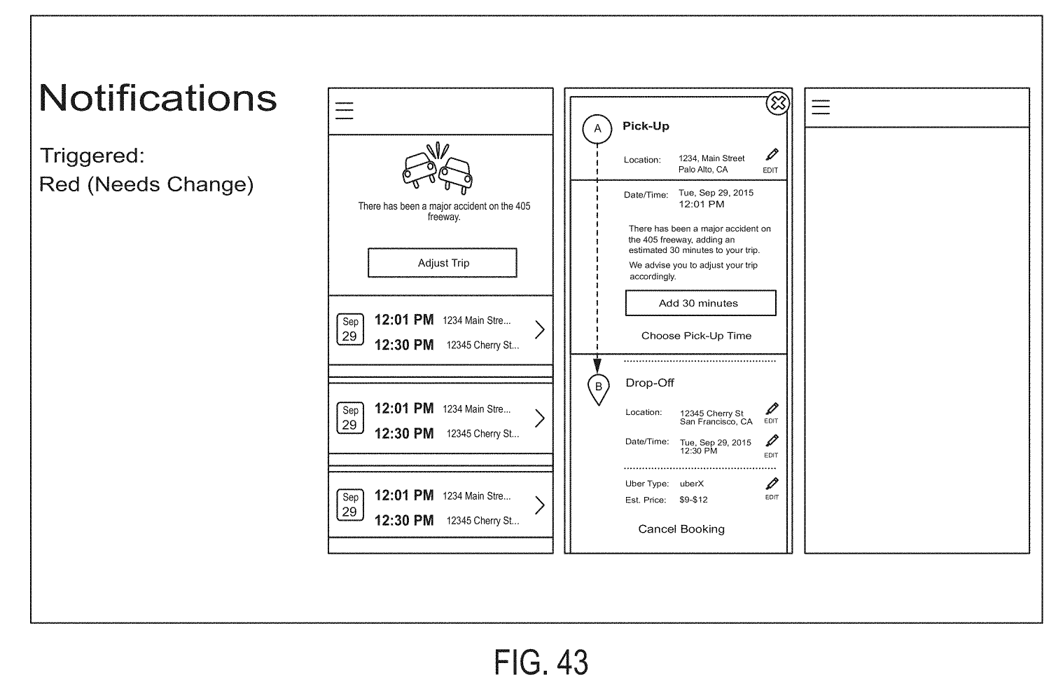

FIG. 42 depicts representative notifications which may be sent to a traveler in act 208 if observed travel conditions are almost certain to affect the trip. In the example shown in FIG. 42, a notification of an accident along the travel route is shown. In the example shown, this notification is designated a “red flag,” in that it notifies the traveler of conditions which almost certainly will affect the traveler's trip. As such, in the example shown, the traveler may change the pick-up time, ridesharing option, and/or other details of the planned trip. By selecting the trip on the interface shown in FIG. 42, the traveler causes the interface shown in FIG. 43 to be shown, which allows the user to make such changes as “add 30 minutes” to the travel time by moving up the pick-up time, “cancel booking,” and “edit” the trip by changing the pick-up location. Any of numerous types of changes to a trip may be made.

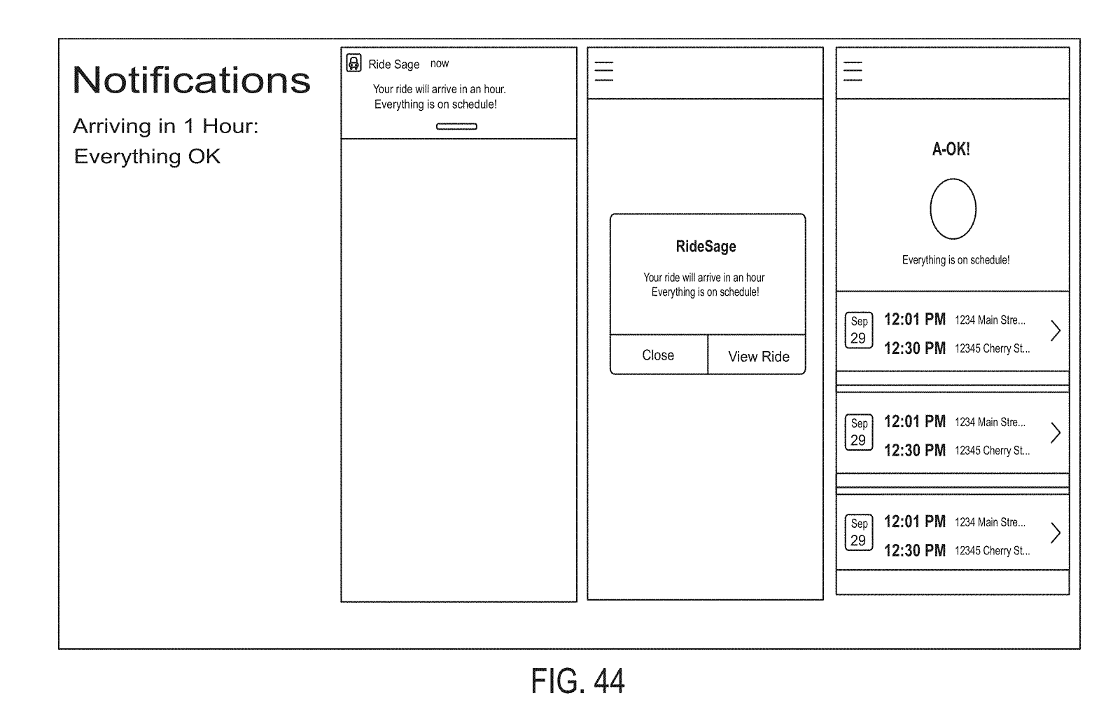

The process of FIG. 39 then proceeds to act 209, wherein the traveler is notified that a booked ride is on the way. FIG. 44 depicts representative screen interfaces which may be presented to a traveler to inform him/her that a previously-booked ride will arrive on schedule.

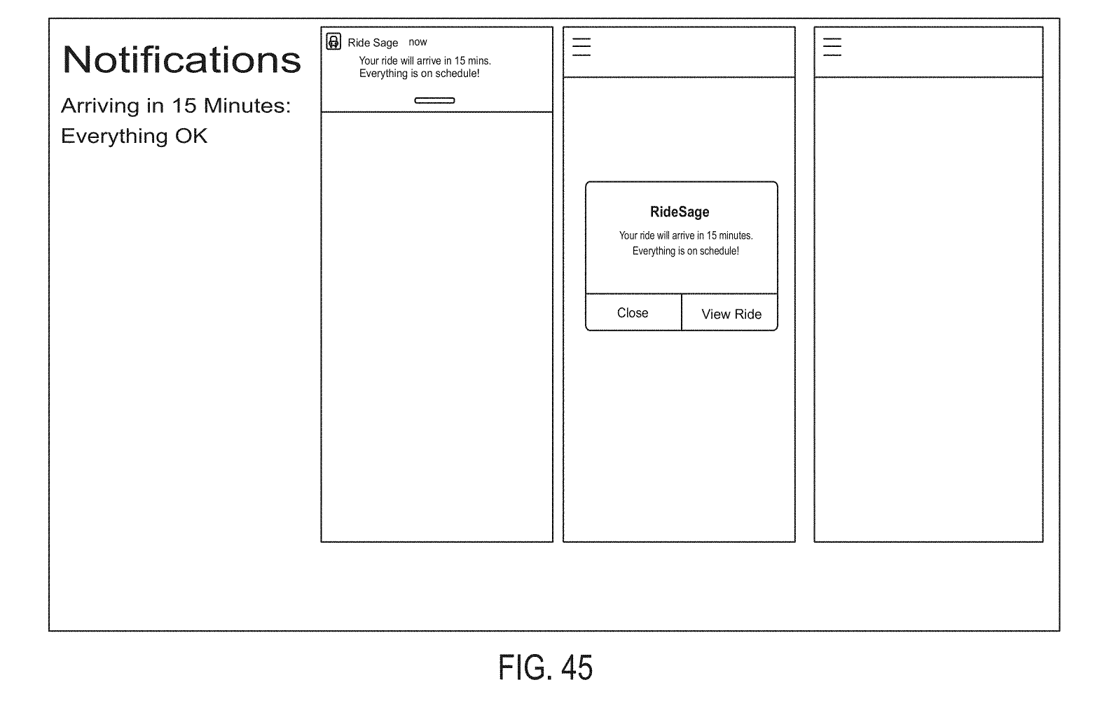

Some embodiments may provide for a traveler to also receive advance notification closer to pick-up time, such as 15 minutes beforehand, 10 minutes beforehand, etc. In this respect, FIG. 45 depicts representative screen interfaces which may be presented to notify a traveler that his/her ride will arrive in 15 minutes.

The process of FIG. 39 then proceeds to act 210, wherein the traveler is notified that his/her ride has arrived. In act 211, the ride takes place. In the act 212, at the completion of the traveler's ride, a receipt is presented.

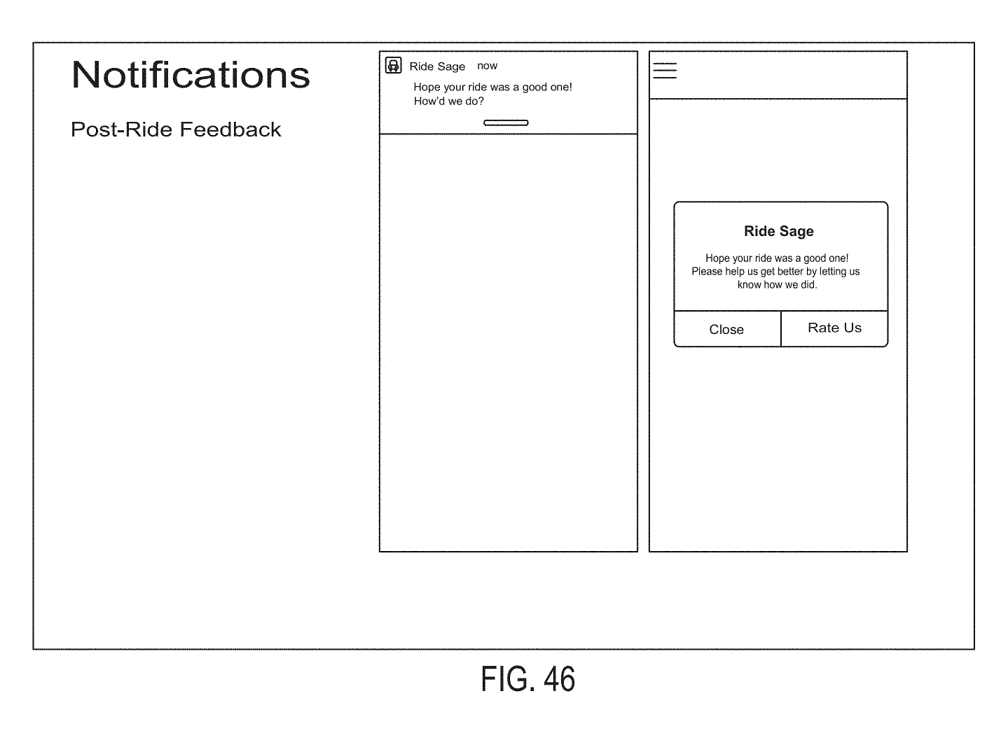

The process then proceeds to act 213, wherein the traveler is prompted to provide post-ride feedback. FIG. 46 depicts representative screen interfaces which may be shown to prompt a traveler to provide feedback.

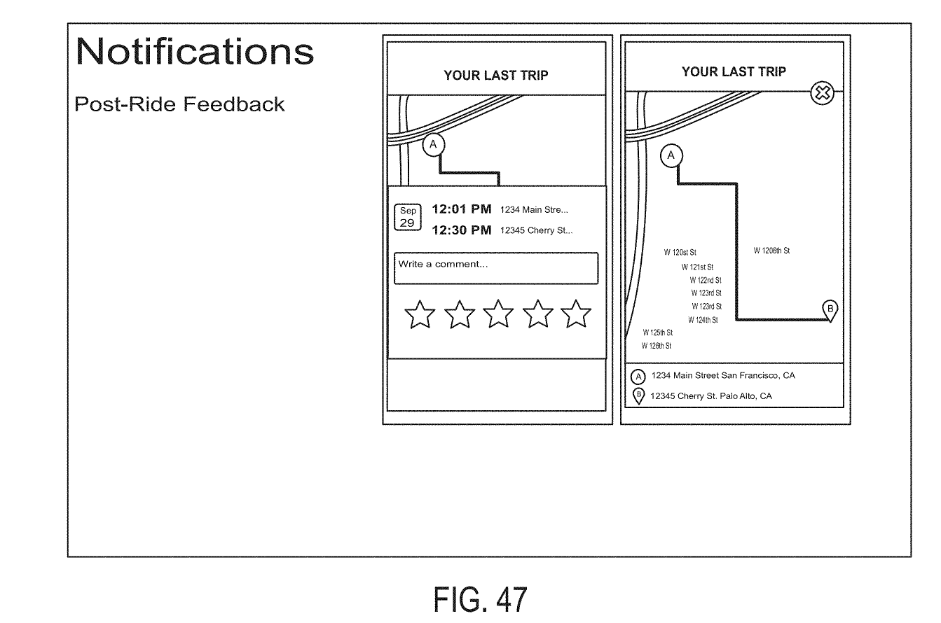

A determination is then made in act 214 whether the user opts to provide feedback. If not, the process returns to the start, and then resumes as described above. If the user opts to provide feedback, the process proceeds to act 215, wherein feedback may be provided, in any of various ways. FIG. 47 depicts representative screen interfaces through which a traveler may provide feedback on a trip, such as to assign an overall “star” rating and provide comments. The traveler may be reminded of the trip for which feedback is being provided, so that the traveler does not confuse multiple previous trips. At the completion of act 215, the process returns to the start, and then resumes as described above.

D. Implementation Details

It should be appreciated that numerous variations on the representative processes described above with reference to FIGS. 1, 23 and 39 are possible. As one example, although the processes of FIGS. 1 and 23 include routines for signing a traveler into a particular ridesharing service, so that the traveler then selects from ridesharing options provided by only that particular ridesharing service, some embodiments of the invention may enable travelers to select ridesharing options from more than one ridesharing service, and/or any of multiple other modes of transportation (e.g., public transit, taxi, limo, etc.).

As another example, the acts described with reference to the processes of FIGS. 1, 23 and 39 need not be performed in the particular sequence described above. Each process may include additional acts not described above, and/or may not include all of the acts described above.

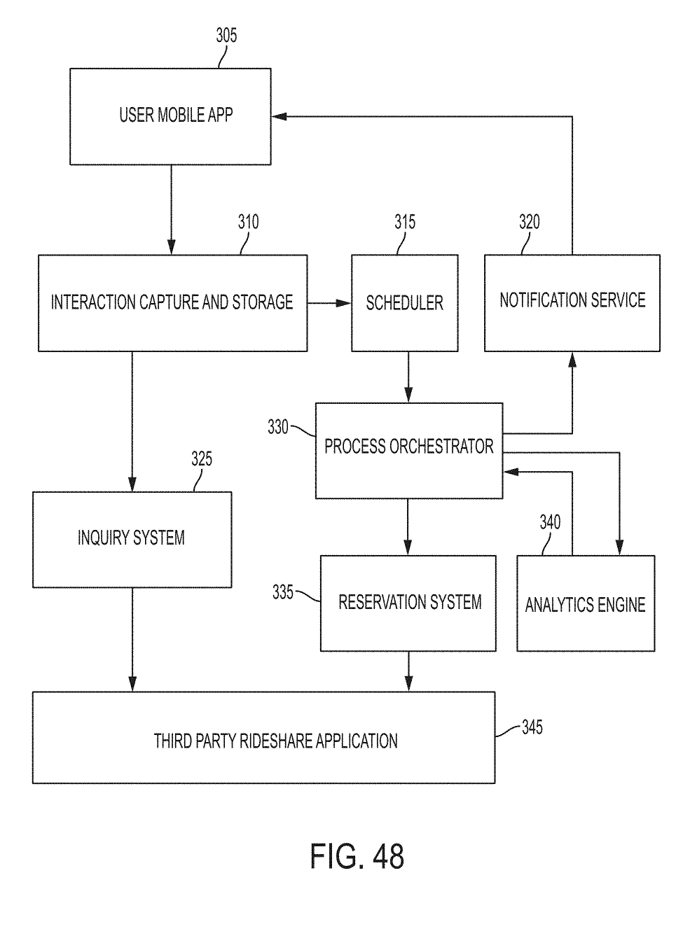

As noted above, in some embodiments of the invention, an app executing on a traveler's mobile device may communicate with one or more modules, which may execute on any suitable computing device(s). In some embodiments, the module(s) may exchange information with a third party rideshare application, such as which may be managed by a ridesharing service. FIG. 48 depicts a representative architecture. In the architecture shown in FIG. 48, interaction capture and storage module 310 receives information from user mobile app 305, such as input provided by a traveler to the app to specify the details of a trip (e.g., pick up time and location, drop off time and location, etc.). Interaction capture and storage module 310 provides information relating to a ride to be scheduled to scheduler module 315, which may, in some embodiments, determine some details about a scheduled trip based on other information about the trip provided by the user. For example, if a user employs the functionality which allows him/her to specify a drop off location and time and have the system automatically determine when he/she should be picked up, scheduler module 315 may perform such calculation.

Process orchestrator module 330 receives information on scheduled trips from schedule module 315, and orchestrates communication amongst other modules to keep the traveler informed as to the trip, and to communicate with a third party rideshare application to reserve the trip. In this respect, process orchestrator module 330 may communicate via reservation system module 335 to reserve a ride through third party ride share application 345. For example, if a traveler has employed the functionality which allows a traveler to specify a drop off time and have the system automatically calculate a pick up time, processor orchestrator module 330 may work through reservation system module 335 to reserve a ride for pick up at the calculated time through third party ride share application 345. If, after the time the traveler books the ride but before the ride actually commences, the traveler should be prompted to change his/her travel plans because of a change in circumstances (e.g., weather, traffic, etc.), process orchestrator module 330 may employ notification service module 320 to issue one or more notifications to user mobile app 305. For example, process orchestrator module 330 may instruct notification service 320 to issue notifications which will be automatically presented to the user of a mobile device executing the mobile app 305, whether or not the user is actively using the device at the time the notification is received, so as to get the user's attention.

In the representative architecture shown in FIG. 48, process orchestrator module 330 may provide information on booked and completed trips to analytics engine 340 to glean insights from such information. For example, analytics engine 340 may process feedback received from travelers on completed trips and delays experienced during such trips to cause process orchestrator 330 to increase the amount of buffer time needed for trips due to traffic and/or weather delays. Analytics engine 340 may also process traveler feedback received on the user mobile app 305, and this feedback may be employed in any various ways to modify the information which is presented to travelers via the app by providing such information to process orchestrator 330.

Interaction capture and storage module 310 also provides information received from user mobile app 305 to inquiry system 325, which communicates with third party ride share application 345 to determine whether travelers have the existing accounts with the third party ride share application. For example, if a user of the mobile app 305 indicates that he/she has an existing account with a third party ride share application, such indication may be provided to interaction capture and storage module 310, which may inquire via inquiry system 325 with third party ride share application 345 to verify the traveler's account with the application.

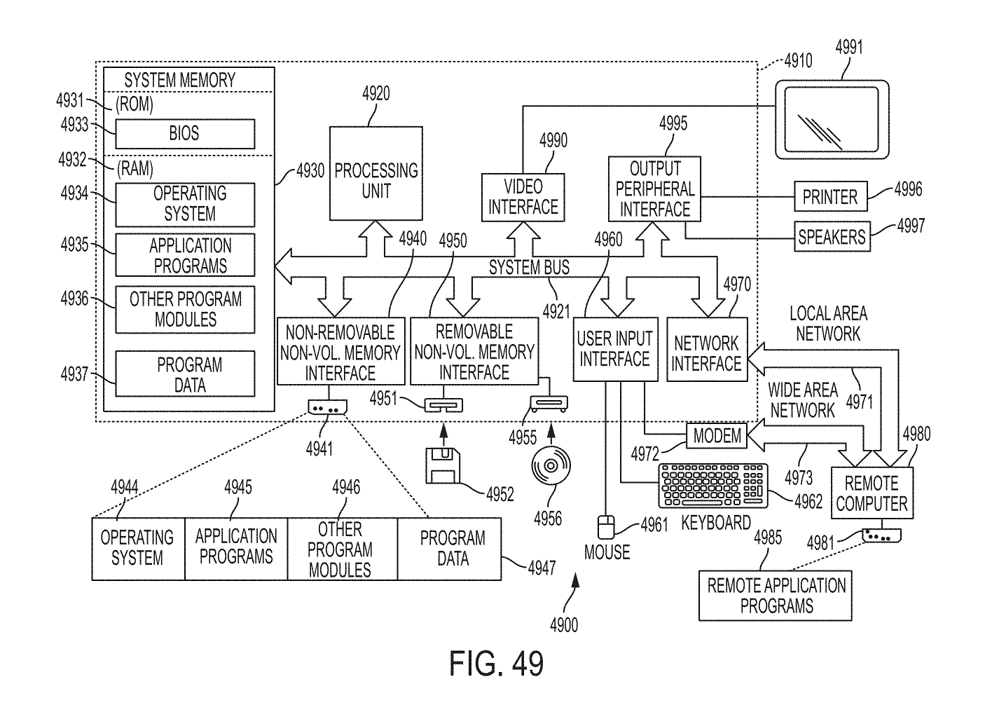

FIG. 49 illustrates one example of a suitable computing system 4900 which may be used to implement certain aspects of the invention. The computing system 4900 is only one example of a suitable computing system, and is not intended to suggest any limitation as to the scope of use or functionality of the invention. Neither should the computing system 4900 be interpreted as having any dependency or requirement relating to any one or combination of components illustrated in the exemplary computing system 4900. In this respect, embodiments of the invention are operational with numerous other general purpose or special purpose computing systems or configurations. Examples of well-known computing systems and/or configurations that may be suitable for use with the invention include, but are not limited to, personal computers, server computers, mobile or laptop devices, multiprocessor systems, microprocessor-based systems, set top boxes, programmable consumer electronics, network PCs, minicomputers, mainframe computers, distributed computing systems that include any of the above systems or devices, and the like.

The computing system may execute computer-executable instructions, such as program modules. Generally, program modules include routines, programs, objects, components, data structures, etc. that perform particular tasks or implement particular abstract data types. The invention may also be practiced in distributed computing systems where tasks are performed by remote processing devices that are linked through a communications network. In a distributed computing system, program modules may be located in both local and remote computer storage media including memory storage devices.

FIG.49 depicts a general purpose computing device in the form of a computer 4910. Components of computer 4910 may include, but are not limited to, a processing unit 4920, a system memory 4930, and a system bus 4921 that couples various system components including the system memory to the processing unit 4920. The system bus 4921 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 4910 typically includes a variety of computer readable media. Computer readable media can be any available media that can be accessed by computer 4910 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other one or more media which may be used to store the desired information and may be accessed by computer 4910. Communication media typically embody computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared and other wireless media. Combinations of the any of the above should also be included within the scope of computer readable media.

The system memory 4930 includes computer storage media in the form of volatile and/or nonvolatile memory such as read only memory (ROM) 4931 and random access memory (RAM) 4932. A basic input/output system 4933 (BIOS), containing the basic routines that help to transfer information between elements within computer 4910, such as during start-up, is typically stored in ROM 4931. RAM 4932 typically contains data and/or program modules that are immediately accessible to and/or presently being operated on by processing unit 4920. By way of example, and not limitation, FIG. 49 illustrates operating system 4934, application programs 4935, other program modules 4936, and program data 4937.

The computer 4910 may also include other removable/non-removable, volatile/nonvolatile computer storage media. By way of example only, FIG. 49 illustrates a hard disk drive 4941 that reads from or writes to non-removable, nonvolatile magnetic media, a magnetic disk drive 4951 that reads from or writes to a removable, nonvolatile magnetic disk 4952, and an optical disk drive 4955 that reads from or writes to a removable, nonvolatile optical disk 4956 such as a CD ROM or other optical media. Other removable/non-removable, volatile/nonvolatile computer storage media that can be used in the exemplary computing system include, but are not limited to, magnetic tape cassettes, flash memory cards, digital versatile disks, digital video tape, solid state RAM, solid state ROM, and the like. The hard disk drive 4941 is typically connected to the system bus 4921 through an non-removable memory interface such as interface 4940, and magnetic disk drive 4951 and optical disk drive 4955 are typically connected to the system bus 4921 by a removable memory interface, such as interface 4950.

The drives and their associated computer storage media discussed above and illustrated in FIG. 49, provide storage of computer readable instructions, data structures, program modules and other data for the computer 4910. In FIG. 49, for example, hard disk drive 4941 is illustrated as storing operating system 4944, application programs 4945, other program modules 4946, and program data 4947. Note that these components can either be the same as or different from operating system 4934, application programs 4935, other program modules 4936, and program data 4937. Operating system 4944, application programs 4945, other program modules 4946, and program data 4947 are given different numbers here to illustrate that, at a minimum, they are different copies. A user may enter commands and information into the computer 4910 through input devices such as a keyboard 4962 and pointing device 4961, commonly referred to as a mouse, trackball or touch pad. Other input devices (not shown) may include a microphone, joystick, game pad, satellite dish, scanner, or the like. These and other input devices are often connected to the processing unit 4920 through a user input interface 4960 that is coupled to the system bus, but may be connected by other interface and bus structures, such as a parallel port, game port or a universal serial bus (USB). A monitor 4991 or other type of display device is also connected to the system bus 4921 via an interface, such as a video interface 4990. In addition to the monitor, computers may also include other peripheral output devices such as speakers 4997 and printer 4996, which may be connected through a output peripheral interface 4995.

The computer 4910 may operate in a networked environment using logical connections to one or more remote computers, such as a remote computer 4980. The remote computer 4980 may be a personal computer, a server, a router, a network PC, a peer device or other common network node, and typically includes many or all of the elements described above relative to the computer 4910, although only a memory storage device 4981 has been illustrated in FIG. 49. The logical connections depicted in FIG. 49 include a local area network (LAN) 4971 and a wide area network (WAN) 4973, but may also include other networks. Such networking environments are commonplace in offices, enterprise-wide computer networks, intranets and the Internet.

When used in a LAN networking environment, the computer 4910 is connected to the LAN 4971 through a network interface or adapter 4970. When used in a WAN networking environment, the computer 4910 typically includes a modem 4972 or other means for establishing communications over the WAN 4973, such as the Internet. The modem 4972, which may be internal or external, may be connected to the system bus 4921 via the user input interface 4960, or other appropriate mechanism. In a networked environment, program modules depicted relative to the computer 4910, or portions thereof, may be stored in the remote memory storage device. By way of example, and not limitation, FIG. 49 illustrates remote application programs 4985 as residing on memory device 4981. It will be appreciated that the network connections shown are exemplary and other means of establishing a communications link between the computers may be used.

Embodiments of the invention may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments of the invention discussed above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computers or other processors to implement various aspects of the present invention as discussed above. As used herein, the term “computer-readable storage medium” encompasses only a tangible machine, mechanism or device from which a computer may read information. Alternatively or additionally, the invention may be embodied as a computer readable medium other than a computer-readable storage medium. Examples of computer readable media which are not computer readable storage media include transitory media, like propagating signals.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Further, though advantages of the present invention are indicated, it should be appreciated that not every embodiment of the invention will include every described advantage. Some embodiments may not implement any features described as advantageous herein and in some instances. Accordingly, the foregoing description and drawings are by way of example only.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

The invention may be embodied as a method, of which an example has been described. The acts performed as part of the method may be ordered in any suitable way. Accordingly, embodiments may be constructed in which acts are performed in an order different than illustrated, which may include different acts than those which are described, and/or which may involve performing some acts simultaneously, even though the acts are shown as being performed sequentially in the embodiments specifically described above.

Use of ordinal terms such as “first,” “second,” “third,” etc., to modify an element does not by itself connote any priority, precedence, or order of one element over another or the temporal order in which acts of a method are performed, but are used merely as labels to distinguish one element having a certain name from another element having a same name (but for use of the ordinal term) to distinguish the elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

1. A computing system for enabling a traveler to reserve a ride, the computing system comprising:
at least one computer-readable medium, having instructions encoded thereon; and
at least one computer processor, programmed via the instructions to:
receive first input from the traveler defining a pick-up location at which the traveler is to be picked up to commence the ride;
receive second input from the traveler defining a destination location at which the traveler is to be dropped off to conclude the ride;
receive third input from the traveler, the third input enabling a pick-up time to be determined for the ride; and
based at least in part upon the first, second and third inputs received from the traveler, automatically identify a first transportation provider, affiliated with a first ridesharing service, to provide the ride to the traveler;
wherein the first ridesharing service does not allow travelers to reserve rides more than a predetermined amount of time before a ride commences, and wherein the first, second and third input are received more than the predetermined amount of time prior to the ride commencing.

2. The computing system of claim 1, wherein the at least one computer processor is programmed to receive third input comprising a drop-off time for the ride, and to automatically determine the pick-up time for the ride.

3. The computing system of claim 1, wherein the at least one computer processor is programmed to determining an amount of travel time associated with the ride, and to cause the determined amount of travel time to be presented to the traveler.

4. The computing system of claim 3, wherein the at least one computer processor is programmed to receive fourth input from the traveler indicating dissatisfaction with the determined amount of travel time, and to automatically identify a second transportation provider which will reduce the amount of travel time associated with the ride.

5. The computing system of claim 4, wherein the second transportation provider is associated with a second ridesharing service.

6. The computing system of claim 1, wherein the at least one computer processor is programmed to automatically issue a request for the ride to the first ridesharing service at a time at which the predefined amount of time remains before the pick-up time.

7. A computing system for enabling a traveler to reserve a ride, the computing system comprising:
at least one computer-readable medium, having instructions encoded thereon; and
at least one computer processor, programmed via the instructions to:
receive first input from the traveler defining a pick-up location at which the traveler is to be picked up to commence the ride;
receive second input from the traveler defining a destination location at which the traveler is to be dropped off to conclude the ride;
based at least in part on the first and second inputs, automatically identify a plurality of ride options for the traveler, each of the plurality of ride options having an associated estimated cost and number of seats;
cause information on each of the plurality of automatically identified ride options to be presented to the traveler, the information for each ride option comprising the estimated cost and number of seats; and
receive third input from the traveler selecting a particular ride option, from the plurality of automatically identified ride options, for the ride;
wherein at least one of the plurality of ride options is to be provided by a ridesharing service which does not allow travelers to reserve rides more than a predetermined amount of time before a ride commences, and wherein the first and second input are received more than the predetermined amount of time prior to the ride commencing.

8. The computing system of claim 7, wherein each of the plurality of automatically identified ride options is affiliated with a different ridesharing service.

9. The computing system of claim 7, wherein the at least one computer processor is programmed to cause the information on the plurality of automatically identified ride options to be presented to the traveler in an order defined by the cost and/or number of seats associated with each ride option.

10. The computing system of claim 7, wherein the at least one computer processor is programmed to receive fourth input defining a drop-off time, and to automatically determine a pick-up time based on the fourth input.

11. A computing system for enabling a traveler to reserve a ride, the computing system comprising:
at least one computer-readable medium, having instructions encoded thereon; and
at least one computer processor, programmed via the instructions to:
receive input from a first traveler to reserve a ride with a ridesharing service, the ride to commence at a first time when the traveler is to be picked up, and to end at a second time when the traveler is to be dropped off;
after the input is received and before the first time, determining that the ridesharing service is unable to both pick up the traveler at the first time and drop off the traveler at the second time;
in response to the determining, prompting the traveler to change at least one of the ridesharing service, the first time when the traveler is to be picked up, and the second time when the traveler is to be dropped off.

12. The computing system of claim 11, wherein the at least one computer processor is programmed to receive information on a weather event predicted to affect travel along a route for the ride between the first time and the second time.

13. The computing system of claim 11, wherein the ridesharing service does not allow travelers to reserve rides more than a predetermined amount of time before a ride commences, and wherein the at least one computer processor is programmed to receive the input more than the predetermined amount of time prior to the ride commencing.

14. The computing system of claim 11, wherein the at least one computer processor is programmed to prompt the traveler to make the pick-up time earlier by a predetermined amount of time.

15. The computing system of claim 11, wherein the at least one computer processor is programmed to receive input from the traveler indicating that the ride is to be cancelled.
